(19) United States
(12) Patent Application Publication
(10) Pub. No.: US 2023/0018380 A1
(43) Pub. Date: Jan. 19, 2023

(54) HUMIDIFIER

(71) Applicant: Mahle International GmbH, Stuttgart (DE)

(72) Inventor: Sven Alexander Kaiser, Waiblingen (DE)

(21) Appl. No.: 17/863,362

(22) Filed: Jul. 12, 2022

(30) Foreign Application Priority Data
Jul. 13, 2021 (DE) 10 2021 207 424.3

(51) Int. Cl. H01M 8/04119; B01D 63/08

(52) U.S. Cl. CPC H01M 8/04149; H01M 8/04141; B01D 63/0822

(57) ABSTRACT

A humidifier for humidifying a dry cathode supply air via a humid cathode exhaust air in a fuel cell system, may include a housing, a membrane stack, and/or a sealing arrangement. The membrane stack may include a plurality of membranes, two first side surfaces, two second side surfaces, and/or two third side surfaces. The plurality of membranes may be stacked on one another transversely to a longitudinal direction of the membrane stack. The first side surfaces may be arranged opposite one another. The second side surfaces may be arranged opposite one another. The third side surfaces may be arranged opposite one another. The sealing arrangement may include two sealing frames, each of the sealing frames is assigned to one of the respective first side surfaces. Each of the sealing frames may have a frame-shaped contact area and a retaining edge protruding from the contact area.

### CROSS-REFERENCE TO RELATED APPLICATION

This application claims priority to German Patent Application No. DE102021207424.3 filed Jul. 13, 2021, the contents of which is hereby incorporated by reference in its entirety.

### TECHNICAL FIELD

The invention relates to a humidifier for humidifying a dry cathode supply air by means of a humid cathode exhaust air in a fuel cell system.

### BACKGROUND

A humidifier of this type usually comprises a housing and a membrane stack, which is accommodated in the housing and has a plurality of membranes stacked at a distance from one another. Channels are formed between the adjacent membranes of the membrane stack, through which the cathode supply air and the cathode exhaust air flow alternately. The membranes are impermeable to air and permeable to water vapor, so that the cathode supply air and the cathode exhaust air are separated by the membranes and the cathode supply air can still be humidified through the membranes with the cathode exhaust air. DE 10 2014 006 394 A1, for example, discloses the airtight separation of the cathode supply air and the cathode exhaust air in the housing of the humidifier by means of a plurality of seals. The disadvantage of this is that the humidifier has a very complex structure.

### SUMMARY

The object of the invention is therefore to provide an improved or at least alternative embodiment for a humidifier of the generic type, in which the disadvantages described are overcome.

The problem is solved according to the invention by the subject—matter of the independent claim 1. Advantageous embodiments are the subject—matter of the dependent claims, the description, and the drawings.

A humidifier in a fuel cell system is used to humidify a dry cathode supply air using a humid cathode exhaust air. The humidifier has a housing and a membrane stack with a plurality of membranes stacked on one another transversely to the longitudinal direction of the membrane stack. The membrane stack has two first side surfaces through which air can flow, two second side surfaces through which air can flow and two third airtight side surfaces. The respective side surfaces are arranged opposite each other. In addition, the first side surfaces are aligned transversely to the longitudinal direction and the remaining side surfaces are aligned parallel to the longitudinal direction. The respective side surfaces delimit the membrane stack from the outside. The humidifier also has a sealing arrangement with two sealing frames, with the respective sealing frame being assigned to the respective first side surface. According to the invention, the respective sealing frame has a frame—shaped contact area aligned transversely to the longitudinal direction and a retaining edge protruding from the contact area in the longitudinal direction. The contact area of the respective sealing frame bears against the respective first flow surface, at least in some areas, and its retaining edge faces the membrane stack. The retaining edge of the respective sealing frame surrounds the membrane stack at a distance, and as a result, a respective groove surrounding the membrane stack is formed between the retaining edge and the membrane stack. The respective groove is filled with an adhesive and the respective sealing frame is bonded to the membrane stack in a sealing manner.

The respective sealing frames can advantageously be used to reliably seal off the respective side surfaces of the membrane stack through which air can flow from one another. The sealing frame is bonded to the membrane stack and is thus integrally bonded. In addition, the first side surfaces through which air can flow and the second side surfaces through which air can flow can be separated from one another in an airtight manner within the housing by the respective sealing frame. The respective sealing frame or the contact area of the respective sealing frame is frame-shaped and surrounds the edge of the respective first side surface through which air can flow. Air can therefore flow through the respective first side surface through which air can flow, namely by flowing through the respective sealing frame or through the contact area of the respective sealing frame.

In the humidifier, the first side surfaces of the membrane stack through which air can flow are aligned transversely to the longitudinal direction. The longitudinal direction is aligned parallel to the membranes of the membrane stack. The membrane stack can advantageously be pushed into the housing in the longitudinal direction. The membrane stack can advantageously be cuboid. The longest edges of the membrane stack can advantageously be aligned parallel to the longitudinal direction. A geometric surface of the respective first side surface can advantageously be smaller than a geometric surface of the respective second side surface and/or than a geometric surface of the respective third side surface. The respective third airtight side surfaces can be formed by the respective last membrane of the membrane stack. The membranes are impermeable to air and permeable to water vapor, so that the third side surfaces remain airtight.

In connection with the present invention, the term “adhesive” is understood to mean, in particular, a bonding agent or an adhesive sealant or an adhesive filling. Advantageously, the adhesive filled into the groove can be formless and/or curing. A curing adhesive can cure, for example, by cooling or by crosslinking. The adhesive within the groove can advantageously form a seal that is frame-like and/or continuous and/or surrounds the membrane stack and/or is dimensionally stable. The seal can advantageously be integrally bonded to the respective sealing frame and to the membrane stack. The seal can advantageously be frame-like and/or continuous and/or circumferential and/or dimensionally stable.

In connection with the present invention, the expression “covers [. . . ] in the longitudinal direction” means that the two overlapping elements immediately follow one another in the longitudinal direction or are arranged directly adjacent to one another in the longitudinal direction. A contact surface formed between the two elements is then aligned transversely to the longitudinal direction. Similarly, the term “covers [. . . ] transversely to the longitudinal direction” means that the two overlapping elements directly follow one another or are arranged directly adjacent to one another transversely to the longitudinal direction. A contact surface formed between the two elements is then aligned transversely to the longitudinal direction.

Supply air ducts for the cathode supply air and exhaust air ducts for the cathode exhaust air can advantageously be formed between the membranes of the membrane stack. The supply air ducts can advantageously be assigned to the respective first side surfaces. The cathode supply air can advantageously flow through the membrane stack from one first side surface to the other first side surface via the supply air ducts. The supply air ducts can advantageously be assigned to the respective first side surfaces. The cathode supply air can advantageously flow through the membrane stack from one first side surface to the other first side surface via the supply air ducts. The supply air ducts and the exhaust air ducts can advantageously be aligned perpendicular to one another in the membrane stack. The membranes of the membrane stack can advantageously be impermeable to air and permeable to water vapor. The cathode supply air and the cathode exhaust air can advantageously flow through the membrane stack without mixing. The cathode supply air can advantageously be humidified through the membranes by means of the cathode exhaust air in the membrane stack.

The membranes of the membrane stack can advantageously be bonded to one another at an adhesive edge of the membrane stack connecting the respective first side surface and the respective second side surface and thus integrally bonded. On the adhesive edge of the membrane stack, a first adhesive area through which air cannot flow on the respective first side surface and a second adhesive area through which air cannot flow can be formed on the respective second side surface. The membrane stack has a total of four adhesive edges, which are aligned transversely to the longitudinal direction and parallel to one another. The respective adhesive edge is assigned to one of the first side surfaces and one of the second side surfaces. The respective first or second side surface is then assigned two adhesive edges, which lie opposite one another. The respective first or second side surface is then assigned two first or second mutually opposite adhesive areas. Since air cannot flow through the respective first and second adhesive areas, the geometric area through which flow can flow of the respective first or second side surface is reduced by the area of the two first or second adhesive areas.

It can advantageously be provided that the contact area of the respective sealing frame covers the first adhesive area of the respective first side surface in the longitudinal direction. In particular, the contact area of the respective sealing frame can exclusively cover the first adhesive area of the respective first side surface in the longitudinal direction. In other words, the contact area of the respective sealing frame can cover the respective first side surface in the longitudinal direction in such a way that regions through which air can flow of the first side surface are not covered and air can still flow through. As a result, the geometric area through which air can flow of the respective first side surface is advantageously not reduced by the respective sealing frame. As already explained above, two mutually opposite first adhesive areas are assigned to the respective first side surface. As a result, the contact area of the respective sealing frame can cover the two first adhesive areas in the longitudinal direction and thus bear against the respective first side surface in a tilt—proof manner.

It can advantageously be provided that the retaining edge of the respective sealing frame covers the second adhesive area of the respective second side surface transversely to the longitudinal direction. In particular, the retaining edge of the respective sealing frame can only cover the second adhesive area of the respective second side surface transversely to the longitudinal direction. In other words, the retaining edge of the respective sealing frame can cover the respective first side surface in the longitudinal direction in such a way that regions through which air can flow of the first side surface are not covered and air can still flow through. As a result, the geometric area of the respective second side surface through which air can flow is advantageously not reduced by the respective sealing frame. It goes without saying that the adhesive in the groove formed between the membrane stack and the retaining edge remains exclusively in the groove and that no areas of the respective second side surface through which flow can flow are thereby covered and thereby blocked.

A connecting edge of the membrane stack connecting the respective first side surface and the respective third side surface can advantageously be formed by a respective edge of the respective last membrane of the membrane stack. At the connecting edge of the membrane stack, air can flow, preferably completely, through the respective first side surface. The term “completely” means that an area through which air can flow of the respective first side surface of the membrane stack is not covered by the contact area of the respective sealing frame and is not reduced. For this purpose, the respective sealing frame can be arranged directly adjacent to the respective connecting edge and not cover the respective first side surface through which air can flow in the longitudinal direction. The membrane stack has a total of four connecting edges, which are aligned transversely to the longitudinal direction and parallel to each other. The respective connecting edge is assigned to one of the first side surfaces and one of the second side surfaces. The respective first or second side surface is then assigned two connecting edges, which lie opposite one another.

It can advantageously be provided that the contact area of the respective sealing frame does not bear against the connecting edge or only covers the edge of the respective last membrane of the membrane stack in the longitudinal direction. In other words, the contact area of the respective sealing frame is moved outwards from the respective first side surface. As a result, the geometric area of the respective second side surface through which air can flow is advantageously not reduced by the respective sealing frame.

It can advantageously be provided that the retaining edge of the respective sealing frame at the connecting edge covers the respective third side surface transversely to the longitudinal direction. As a result, the groove is formed between the respective third side surface and the retaining edge. Since air cannot flow through the respective third side surface, no geometric surface through which air can flow of the membrane stack is blocked as a result. If the groove is filled with the adhesive and the membrane stack is bonded to the respective sealing frame and thereby integrally bonded, the respective first side surface and the respective third side surface are also separated from one another in an airtight manner at the respective connecting edge.

It can be advantageously provided that the respective sealing frame has a plurality of spacer cams. The spacer cams are formed on the retaining edge of the respective sealing frame and face the membrane stack. The respective sealing frame can then bear against the membrane stack with the plurality of spacer cams, so that the respective sealing frame is centered on the membrane stack and the groove has a constant width transverse to the longitudinal direction. Advantageously, the spacer cams can be arranged circumferentially evenly distributed around the respective first side surface or around the membrane stack.

Provision can advantageously be made for the spacer cams of the respective sealing frame to have a smaller height from the contact area in the longitudinal direction than the retaining edge of the respective sealing frame. As a result, the groove can remain connected in the longitudinal direction above the respective spacer cam, despite contact of the respective spacer cams with the membrane stack. The adhesive filled into the groove can thereby form a coherent and frame-like seal and the sealing of the membrane stack can be improved by the respective sealing frame.

It can advantageously be provided that the respective sealing frame has a frame-shaped sealing area and the sealing area is fixed or formed on the contact area facing away from the membrane stack. The sealing area can then sealingly bear against the housing of the humidifier and seal the respective first side surface all around. As a result, the respective first side surfaces of the membrane stack through which air can flow can be separated within the housing from the respective second side surfaces of the membrane stack through which air can flow and from one another in an airtight manner.

It can advantageously be provided that the two second side surfaces through which air can flow are separated from one another in an airtight manner within the housing. The sealing arrangement can advantageously have two sealing plates. The respective sealing plate can bear sealingly on one side against the respective third side surface of the diaphragm stack through which air cannot flow and on the other side against the housing. The respective sealing plate can additionally be bonded integrally and in an airtight manner, for example bonded, to the respective associated third side surface.

Further important features and advantages of the invention will be apparent from the subclaims, the drawings, and the accompanying description of the figures based on the drawings.

It goes without saying that the features mentioned above and those to be explained below may be used not only in the combination indicated in each case, but also in other combinations or separately, without deviating from the scope of the present invention.

### BRIEF DESCRIPTION OF THE DRAWINGS

Preferred exemplary embodiments of the invention are shown in the drawings and will be explained in more detail in the description below, where identical reference numerals denote identical or similar or functionally identical components.

In the schematic drawings:

FIG. 1 shows a view of an arrangement consisting of a membrane stack and a sealing arrangement of a humidifier according to the invention;

FIG. 2 is an exploded view of the assembly shown in FIG. 1;

FIGS. 3 and 4 show a view and a partial view of the membrane stack of the humidifier according to the invention;

FIG. 5 shows a sectional view of the arrangement shown in FIG. 1 transversely to the adhesive edges of the membrane stack;

FIG. 6 shows a sectional view of the arrangement shown in FIG. 1 transversely to the connecting edges of the membrane stack;

FIGS. 7 and 9 show different sectional views of the arrangement shown in FIG. 1 transversely to the adhesive edges of the membrane stack without an adhesive;

FIGS. 8 and 10 show different sectional views of the arrangement shown in FIG. 1 transversely to the adhesive edges of the membrane stack with an adhesive;

FIGS. 11 and 13 show different sectional views of the arrangement shown in FIG. 1 transversely to connecting edges of the membrane stack without an adhesive;

FIGS. 12 and 14 show different sectional views of the arrangement shown in FIG. 1 transversely to connecting edges of the membrane stack with an adhesive;

FIG. 15 is an exploded view of the humidifier according to the present invention.

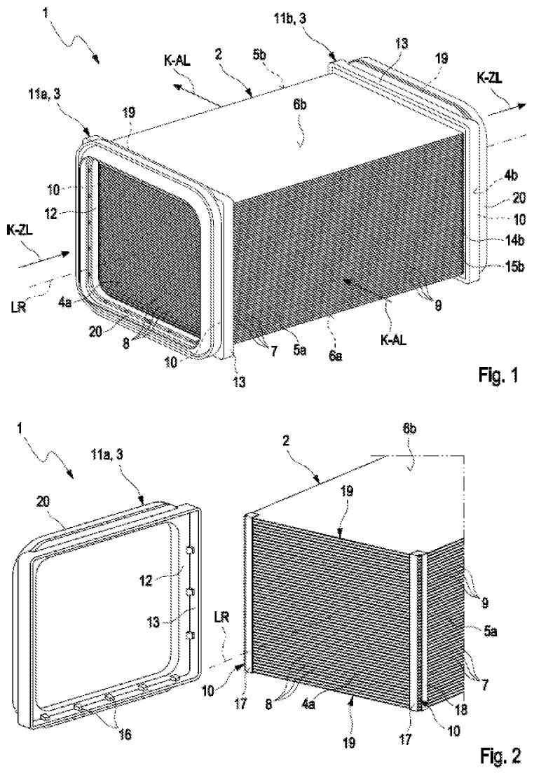

FIG. 1 shows a view of a humidifier 1 according to the invention. The humidifier 1 is provided for humidifying a dry cathode supply air K-ZL by means of a humid cathode exhaust air K-AL in a fuel cell system.

### DETAILED DESCRIPTION

The humidifier 1 comprises a membrane stack 2 and a sealing arrangement 3. In addition, the humidifier 1 comprises a housing 21 shown in FIG. 15, in which the membrane stack 2 and the sealing arrangement 3 arranged on it are accommodated. The housing 21 is not shown here for the sake of clarity.

The membrane stack 2 is cuboid and has two first side surfaces 4a and 4b, two second side surfaces 5a and 5b and two third side surfaces 6a and 6b. A longitudinal direction LR is defined in the membrane stack 2, with the first side surfaces 4a and 4b being aligned transversely to the longitudinal direction LR. The second side surfaces 5a and 5b and the third side surfaces 6a and 6b are correspondingly aligned parallel to the longitudinal direction LR. It goes without saying that the respective side surfaces 4a, 4b, 5a, 5b, 6a, 6c form a contour of the membrane stack 2 which is closed towards the outside.

The membrane stack 2 has a plurality of membranes 7 — here flat membranes — stacked transversely to the longitudinal direction LR of the membrane stack 2 at a distance from one another. As a result, in the membrane stack 2, air can flow through the first side surfaces 4a and 4b as well as through the second side surfaces 5a and 5b, whereas air cannot flow through the third side surfaces 6a and 6b or they are airtight. Supply air ducts 8 through which cathode supply air K-ZL can flow and exhaust air ducts 9 through which cathode exhaust air K-AL can flow are formed between the individual membranes 7. The membranes 7 of the membrane stack 2 are airtight and permeable to water vapor, so that the cathode supply air K-ZL and the cathode exhaust air K-AL flow through the membrane stack 2 without mixing, while the cathode supply air K-ZL within the membrane stack 2 is humidified via the membranes 7 by the cathode exhaust air K-AL. In the membrane stack 2 shown here, the dry cathode supply air K-ZL can flow through the first side surfaces 4a and 4b and the humid cathode exhaust air K-AL can flow through the second side surfaces 5a and 5b.

The sealing arrangement 3 has two sealing frames 11a and 11b, the respective sealing frame 11a or 11b being assigned to the respective first side surface 4a or 4b. The respective sealing frame 11a or 11b has a frame-shaped contact area 12, which is aligned transversely to the longitudinal direction LR, and a retaining edge 13, which protrudes from the contact area 12 in the longitudinal direction LR toward the membrane stack 2. The retaining edge 13 surrounds the contact area 12 on the outside. The contact area 12 of the respective sealing frame 11a or 11b bears against the respective first side surface 4a or 4b. The retaining edge 13 of the respective sealing frame 11a or 1 lb surrounds the membrane stack 2 at a distance, so that a circumferential groove 14a or 14b is formed between the retaining edge 13 and the membrane stack 2 in each case. The respective groove 14a or 14b is filled with an adhesive and the respective sealing frame 11a or 11b is sealingly bonded to the membrane stack. The adhesive is shapeless and forms a surrounding frame-like seal 15a or 15b after curing, which is arranged in the respective groove 14a or 14b and is integrally bonded to the membrane stack 2 and to the respective sealing frame 11a or 11b.

Moreover, the respective sealing frame 11a or 11b has a frame-like sealing area 20. The sealing area 20 is formed on the contact area 12 and faces away from the membrane stack 2 or from the retaining edge 13. If the membrane stack 2 is arranged in the housing 21—see FIG. 15—then the sealing area 20 sealingly bears against the housing and seals off the respective first side surface 4a or 4b from the remaining side surfaces within the housing 21 through which air can flow.

FIG. 2 shows an exploded view of the humidifier 1 according to the invention. In FIG. 2, the sealing frame 11a is separated from the membrane stack 2 and the sealing frame 11b is not visible. Since the two sealing frames 11a and 11b are identical to each other, the following description applies to the two sealing frames 11a and 11b. The respective sealing frame 11a or 11b has a plurality of spacer cams 16 which are formed on the retaining edge 13 of the respective sealing frame 11a or 11b. The spacer cams 16 face the membrane stack 2 and are in contact with the membrane stack 2. As a result, the respective sealing frame 11a or 11b is centered on the membrane stack 2 and the respective groove 14a or 14b has a constant width transverse to the longitudinal direction LR. The spacer cams 16 also have—measured from the contact area 12 in the longitudinal direction LR—a smaller height than the retaining edge 13. As a result, the seal 15a or 15b formed by the adhesive in the respective groove 14a or 14b is continuous all the way around.

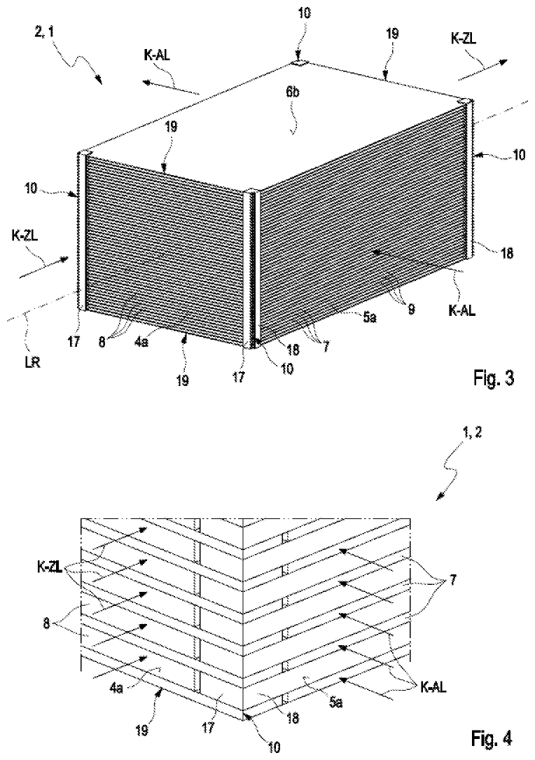

FIG. 3 shows a view of the membrane stack 2 of the humidifier 1 according to the invention. It can be seen particularly clearly in FIG. 3 that the individual membranes 7 of the membrane stack 2 are bonded together at a total of four adhesive edges 10. The respective adhesive edge 10 is formed between the respective first side surface 4a or 4b and the respective second side surface 5a or 5b. On the respective adhesive edge 10, first adhesive areas 17 through which air cannot flow and second adhesive areas 18 through which air cannot flow are formed by the adhesive bonding of the individual membranes 7. The first adhesive areas 17 are assigned to the respective first side surface 4a or 4b and the second adhesive areas 18 are assigned to the respective second side surface 5a or 5b.

Two opposing first adhesive areas 17 are arranged on the respective first side surface 4a or 4b. Two opposite second adhesive areas 18 are arranged on the respective second side surface 5a or 5b. Air cannot flow through the adhesive areas 17 and 18 and they reduce a geometric flowable area of the respective first side surfaces 4a and 4b and of the respective second side surfaces 5a and 5b.

In addition, four connecting edges 19 are formed in the membrane stack 2 between the respective first side surface 4a or 4b and the respective third side surface 6a or 6b. The respective connecting edge 19 is formed by an edge of the respective last membrane 7 of the membrane stack 2. At the respective connecting edge 19, a geometric surface through which air can flow of the respective first side surface 4a or 4b is therefore not reduced. The respective connecting edges 19 are aligned transversely to the longitudinal direction LR. The respective first side surface 4a or 4b is assigned two connecting edges 19 lying opposite one another.

FIG. 4 shows a partial view of the membrane stack 2 of the humidifier 1 according to the invention at the adhesive edge 10. In FIG. 4, the respective first adhesive area 17 and the respective second adhesive area 18 at the respective adhesive edge 10 are particularly well visible. It can also be seen that the respective connecting edge 19 is formed by the edge of the last membrane 7 of the membrane stack 2.

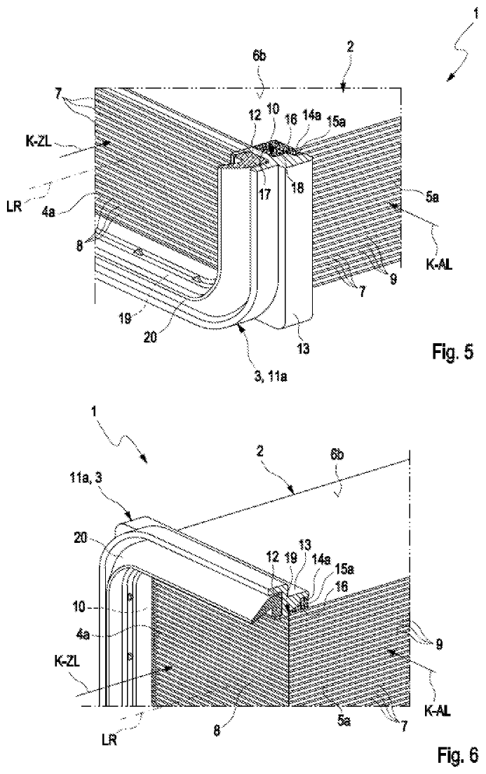

FIG. 5 shows a sectional view of the membrane stack 2 with the sealing arrangement 3 transversely to the adhesive edges 10 of the membrane stack 2. In FIG. 5, the sealing frame 11a is shown and the sealing frame 11b is not visible. Since the two sealing frames 11a and 11b are identical to each other, the following description applies to the two sealing frames 11a and 11b. The contact area 12 of the respective sealing frame 11a or 11b covers only the first adhesive area 17 of the respective first side surface 4a or 4b in the longitudinal direction LR. The retaining edge 13 of the respective sealing frame 11a or 11b covers only the second adhesive area 18 of the respective second side surface 5a or 5b transversely in the longitudinal direction LR. In other words, the contact area 12 and the retaining edge 13 of the respective sealing frame 11a or 11b do not cover any areas of the respective first side surface 4a or 4b and the respective second side surface 5a or 5b through which air can flow. As a result, the flow through the membrane stack 2 on the respective first side surface 4a or 4b and the respective second side surface 5a or 5b is not negatively influenced by the sealing frame 11a or 11b.

FIG. 6 shows a sectional view of the membrane stack 2 with the sealing arrangement 3 transversely to the connecting edges 19 of the membrane stack 2. In FIG. 6 the sealing frame 11a is shown and the sealing frame 11b is not visible. Since the two sealing frames 11a and 11b are identical to each other, the following description applies to the two sealing frames 11a and 11b. The contact area 12 of the respective sealing frame 11a or 11b does not cover the respective first side surface 4a or 4b in the longitudinal direction LR. As a result, the flow through the membrane stack 2 on the respective first side surface 4a or 4b is not negatively influenced by the sealing frame 11a or 11b. However, the retaining edge 13 of the respective sealing frame 11a or 11b partially covers the respective third side surfaces 5a or 5b transversely to the longitudinal direction LR. Similarly, since air cannot flow through the respective third side surfaces 6a and 6b, the flow through the membrane stack 2 is not negatively influenced.

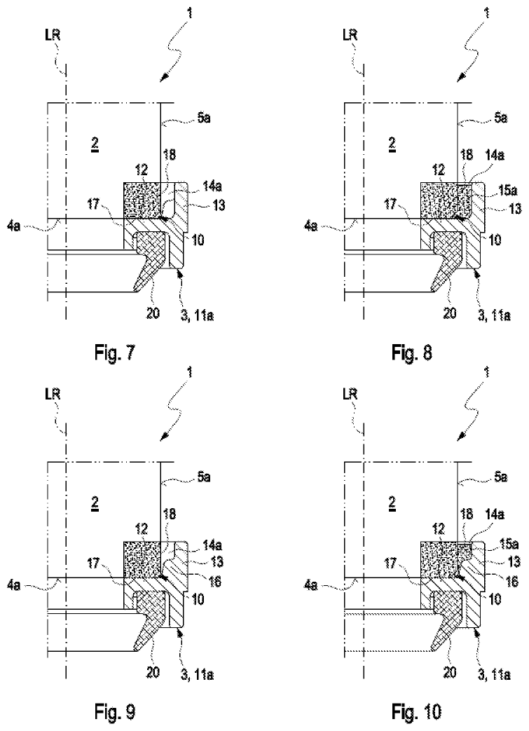

FIGS. 7 to 10 show different sectional views of the membrane stack 2 with the sealing arrangement 3 transversely to the adhesive edges 10. In FIGS. 7 to 10, the sealing frame 11a is shown and the sealing frame 11b is not visible. Since the two sealing frames 11a and 11b are identical to each other, the description of FIGS. 7 to 10 applies to the two sealing frames 11a and 11b.

FIG. 7 shows a sectional view of the membrane stack 2 with the sealing arrangement 3 transversely to the adhesive edges 10 of the membrane stack 2. Here, the sectional plane through the respective groove 14a or 14b lies outside of the spacer cams 16 in the respective groove 14a or 14b. The groove 14a or 14b is also shown without the adhesive and correspondingly without the respective seal 15a or 15b formed from the cured adhesive.

FIG. 8 shows a sectional view of the membrane stack 2 with the sealing arrangement 3 transversely to the adhesive edges 10 of the membrane stack 2. Here, the sectional plane through the respective groove 14a or 14b lies outside of the spacer cams 16 in the respective groove 14a or 14b. The groove 14a or 14b is also shown without the adhesive and correspondingly without the respective seal 15a or 15b formed from the cured adhesive.

FIG. 9 shows a sectional view of the membrane stack 2 with the sealing arrangement 3 transversely to the adhesive edges 10 of the membrane stack 2. Here, the sectional plane through the respective groove 14a or 14b lies through one of the spacer cams 16 in the respective groove 14a or 14b. The groove 14a or 14b is also shown without the adhesive and correspondingly without the respective seal 15a or 15b formed from the cured adhesive.

FIG. 10 shows a sectional view of the membrane stack 2 with the sealing arrangement 3 transversely to the adhesive edges 10 of the membrane stack 2. Here, the sectional plane through the respective groove 14a or 14b lies through one of the spacer cams 16 in the respective groove 14a or 14b. The groove 14a or 14b is also shown without the adhesive and correspondingly without the respective seal 15a or 15b formed from the cured adhesive.

As can be seen particularly well in FIGS. 7 to 10, the respective sealing frame 11a or 11b does not cover any areas of the respective first side surface 4a or 4b and the respective second side surface 5a or 5b through which air can flow. This does not affect the flow through the membrane stack 2. As already explained above, the respective spacer cam 16—measured from the contact area 12 in the longitudinal direction LR—also has a smaller height than the retaining edge 13 of the respective sealing frame 11a or 11b. As a result, the seal 15a or 15b formed in the groove 14a or 14b is frame-like and continuous.

FIGS. 11 to 14 show different sectional views of the membrane stack 2 with the sealing arrangement 3 transversely to the connecting edges 19. In FIGS. 11 to 14, the sealing frame 11a is shown and the sealing frame 11b is not visible. Since the two sealing frames 11a and 11b are identical to each other, the description of FIGS. 11 to 14 applies to the two sealing frames 11a and 11b.

FIG. 11 shows a sectional view of the membrane stack 2 with the sealing arrangement 3 transversely to the connecting edges 19 of the membrane stack 2. Here, the sectional plane through the respective groove 14a or 14b lies outside of the spacer cams 16 in the respective groove 14a or 14b. The groove 14a or 14b is also shown without the adhesive and correspondingly without the respective seal 15a or 15b formed from the cured adhesive.

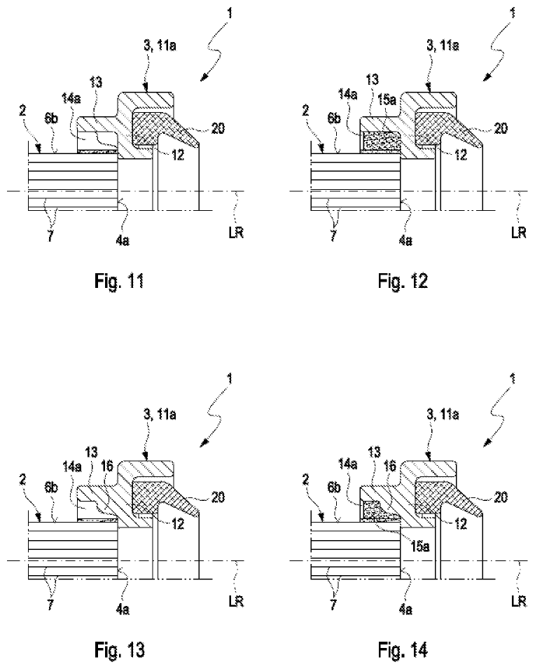

FIG. 12 shows a sectional view of the membrane stack 2 with the sealing arrangement 3 transversely to the connecting edges 19 of the membrane stack 2. Here, the sectional plane through the respective groove 14a or 14b lies outside of the spacer cams 16 in the respective groove 14a or 14b. The groove 14a or 14b is also shown with the adhesive and correspondingly with the respective seal 15a or 15b formed from the cured adhesive.

FIG. 13 shows a sectional view of the membrane stack 2 with the sealing arrangement 3 transversely to the connecting edges 19 of the membrane stack 2. Here, the sectional plane through the respective groove 14a or 14b lies through one of the spacer cams 16 in the respective groove 14a or 14b. The groove 14a or 14b is also shown without the adhesive and correspondingly without the respective seal 15a or 15b formed from the cured adhesive.

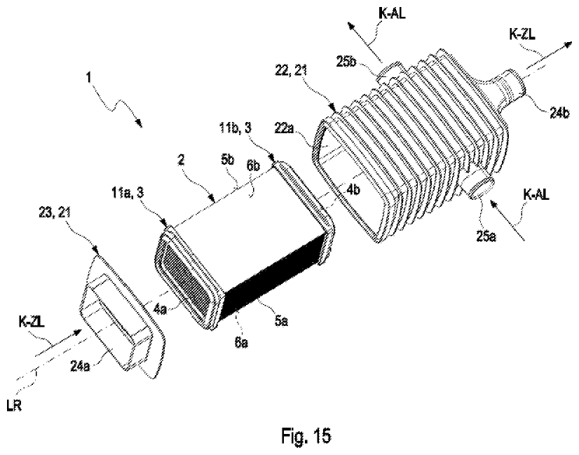

FIG. 14 shows a sectional view of the membrane stack 2 with the sealing arrangement 3 transversely to the connecting edges 19 of the membrane stack 2. Here, the sectional plane through the respective groove 14a or 14b lies through of the spacer cams 16 in the respective groove 14a or 14b. The groove 14a or 14b is also shown with the adhesive and correspondingly with the respective seal 15a or 15b formed from the cured adhesive.

As can be seen particularly well in FIGS. 11 to 14, the respective sealing frame 11a or 11b does not cover any areas through which air can flow of the respective first side surface 4a or 4b. This does not affect the flow through the membrane stack 2 at the respective first side surfaces 4a or 4b. Air cannot flow through the respective third side surfaces 6a and 6b, so that the covering of the respective third side surface 6a or 6b with the retaining edge 13 does not affect the flow through the membrane stack 2 either. As shown in FIGS. 7 to 10, the respective spacer cam 16 in the longitudinal direction LR is smaller than the retaining edge 13 of the respective sealing frame 11a or 11b. As a result, the seal 15a or 15b formed in the groove 14a or 14b is frame-like and continuous.

FIG. 15 shows an exploded view of the humidifier 1 according to the invention. As already explained above, the humidifier has the housing 21 and the membrane stack 2 with the sealing arrangement 3 is accommodated in the housing 21. The housing 21 has a pot-shaped housing body 22 and a cover 23 that is separate from the housing body 22. The cover 23 closes the housing body 22 or an assembly opening 22 in the housing body 22 transversely to the longitudinal direction LR. The membrane stack 2 with the sealing arrangement 3 can be pushed into the housing body 22 along the longitudinal direction LR via the assembly opening 22a.

A total of four air spigots 24a, 24b and 25a, 25b are formed on the housing 21—that is, on the housing body 22 and on the cover 23. The side surfaces 4a and 4b through which air can flow can be connected via the air spigots 24a and 24b and the side surfaces 5a and 5b through which air can flow can be connected to the outside through the air spigots 25a and 25b.

1. A humidifier for humidifying a dry cathode supply air via a humid cathode exhaust air in a fuel cell system, the humidifier comprising:
a housing;
a membrane stack including:
a plurality of membranes stacked on one another transversely to a longitudinal direction of the membrane stack;
two first side surfaces through which air can flow, the first side surfaces are arranged opposite one another;
two second side surfaces through which air can flow, the second side surfaces are arranged opposite one another; and
two third side surfaces arranged opposite one another, wherein the first side surfaces are aligned transversely to the longitudinal direction and the second and third side surfaces are aligned parallel to the longitudinal direction; and
a sealing arrangement including two sealing frames, each of the sealing frames is assigned to one of the respective first side surfaces;
wherein each of the sealing frames has a frame-shaped contact area transversely to the longitudinal direction and a retaining edge protruding from the contact area in the longitudinal direction,
wherein each of the sealing frames bears against one of the respective first side surfaces with the contact area at least in certain areas, and faces the membrane stack with the retaining edge;
wherein the retaining edge surrounds the membrane stack at a distance, thereby forming a respective groove around the membrane stack; and
wherein the respective groove is filled with an adhesive and the respective sealing frame is sealingly bonded to the membrane stack.

2. The humidifier of claim 1, wherein the membranes of the membrane stack are bonded together at an adhesive edge of the membrane stack connecting one of the respective first side surfaces and one of the respective second side surfaces; and
a first adhesive area through which air cannot flow of the respective first side surface and a second adhesive area of the respective second side surface through which air cannot flow are formed on the adhesive edge of the membrane stack.

3. The humidifier of claim 2,
wherein the contact area of one of the respective sealing frames covers the first adhesive area in the longitudinal direction.

4. The humidifier of claim 2, wherein the retaining edge of the respective sealing frame covers the second adhesive area transversely to the longitudinal direction.

5. The humidifier of claim 1, wherein one connecting edge of the membrane stack connecting one of the respective first side surfaces and one of the respective third side surfaces is formed by a respective edge of a respective last membrane of the membrane stack; and
air can flow through the respective first side surface at the connecting edge of the membrane stack.

6. The humidifier of claim 5, wherein the contact area of the respective sealing frame does not bear against the connecting edge or solely covers the edge of the respective last membrane of the membrane stack in the longitudinal direction.

7. The humidifier of claim 5, wherein the retaining edge of the respective sealing frame at the connecting edge covers the respective third side surface transversely to the longitudinal direction.

8. The humidifier of claim 1, wherein several spacer cams facing the membrane stack are formed on the retaining edge of one of the respective sealing frames; and
the respective sealing frame bears against the membrane stack with the several spacer cams, so that the respective sealing frame is centered on the membrane stack and the groove has a constant width transverse to the longitudinal direction.

9. The humidifier of claim 8, wherein the spacer cams have a smaller height from the contact area in the longitudinal direction than the retaining edge.

10. The humidifier of claim 1, wherein each of the respective sealing frames has a frame-shaped sealing area and the sealing area is fastened or formed on the contact area facing away from the membrane stack; and
the sealing area sealingly bears against the housing of the humidifier and circumferentially seals the respective first side surface.

11. A humidifier, comprising:
a housing;
a membrane stack including:
a plurality of membranes stacked on one another transversely to a longitudinal direction of the membrane stack;
a first side surface through which air can flow;
a second side surface through which air can flow; and
a third side surface; and
a sealing arrangement including a sealing frame;
wherein the sealing frame has a frame-shaped contact area transversely to the longitudinal direction and a retaining edge protruding from the contact area in the longitudinal direction;
wherein the sealing frame bears against the first side surface;
wherein the retaining edge surrounds the membrane stack, thereby forming a groove; and
wherein the groove is filled with an adhesive and the sealing frame is sealingly bonded to the membrane stack.

12. The humidifier of claim 11, wherein the membranes are bonded together at an adhesive edge of the membrane stack connecting the first side surface and the second side surface; and
a first adhesive area through which air cannot flow of the first side surface and a second adhesive area of the second side surface through which air cannot flow are formed on the adhesive edge of the membrane stack.

13. The humidifier of claim 12, wherein the contact area of the sealing frame covers the first adhesive area in the longitudinal direction.

14. The humidifier of claim 12, wherein the retaining edge of the sealing frame covers the second adhesive area transversely to the longitudinal direction.

15. The humidifier of claim 11, wherein a connecting edge of the membrane stack connecting the first side surface and the third side surface is formed by an edge of a respective last membrane of the membrane stack; and
air can flow through the first side surface at the connecting edge of the membrane stack.

16. The humidifier of claim 15, wherein the contact area of the sealing frame does not bear against the connecting edge or solely covers the edge of the respective last membrane of the membrane stack in the longitudinal direction.

17. The humidifier of claim 15, wherein the retaining edge of the sealing frame at the connecting edge covers the third side surface transversely to the longitudinal direction.

18. The humidifier of claim 11, wherein several spacer cams facing the membrane stack are formed on the retaining edge of the sealing frame; and
the sealing frame bears against the membrane stack with the several spacer cams, so that the sealing frame is centered on the membrane stack and the groove has a constant width transverse to the longitudinal direction.

19. The humidifier of claim 18, wherein the spacer cams have a smaller height from the contact area in the longitudinal direction than the retaining edge.

20. The humidifier of claim 11, wherein the sealing frame has a frame—shaped sealing area and the sealing area is fastened or formed on the contact area facing away from the membrane stack; and
the sealing area sealingly bears against the housing of the humidifier and circumferentially seals the first side surface.
